(19) United States
(12) Patent Application Publication
(10) Pub. No.: US 2016/0199733 A1
(43) Pub. Date: Jul. 14, 2016

(54) METHOD FOR VIRTUAL COMPETITION USING MOTION COMMAND INPUT, AND COMPUTER PROGRAM

(71) Applicant: Tae Kwan KIM, Seoul (KR)

(72) Inventors: Tae Kwan KIM, Seoul (KR); Ryang Sup AN, Uiwang-si, Gyeonggi-do (KR)

(21) Appl. No.: 14/912,213

(22) PCT Filed: Aug. 14, 2014
(86) PCT No.: PCT/KR2014/007603

§ 371 Date: Feb. 16, 2016

(30) Foreign Application Priority Data
Aug. 16, 2013 (KR) 10-2013-0097005
Aug. 14, 2014 (KR) 10-2014-0106244

(51) Int. Cl. A63F 13/428; A63F 13/65

(52) U.S. Cl. CPC A63F 13/428; A63F 13/65

(57) ABSTRACT

A method for virtual competition using motion command input according to an embodiment of the present invention comprises the steps of: analyzing a motion command and matching same with a particular skill; transmitting the particular skill to a competing client in competition and activiating the particular skill, wherein the particular skill is displayed overlapping the form of a competing user controlling the competing client.

### TECHNICAL FIELD

The present invention relates to a method for virtual competition using motion command input and a computer program, and more particularly, to a method for virtual competition using motion command input, which provides improved visual and control when a virtual competition game among a plurality of users is progressed.

### BACKGROUND ART

Most games using apparatuses including a computer, and the like as a 2D or 3D game are progressed by game programs embedded in a game machine, a PC, or a mobile device. In the game in the related art, it needs to be satisfied for a user to enjoy a game given through a game screen and it is difficult for the user to change game contents. A difficulty of the game varies for each step and game contents of the respective steps are different from each other to allow the user to take an interest, but the game contents of the respective steps are standardized, therefore, overall game contents cannot still deviate from a standardized state.

### DISCLOSURE

### Technical Problem

In the case of the related art, in progressing a cooperation game or a competition game among multiple users, a scheme that controls a game character by recognizing a motion of a user by a motion controller has been proposed, but this just changes an input scheme 3-dimensionally and it is difficult to implement a more 3-dimensional and more realistic game.

An embodiment of the present invention is directed to provide a method for virtual competition, which is implemented through various patterns of motion command input schemes among users actually facing each other offline and a computer program.

Another embodiment of the present invention is directed to provide a method for virtual competition, which is 3-dimensional and realistic in implementing a character and a skill by introducing virtual reality into a virtual competition game and a computer program.

Yet another embodiment of the present invention is directed to provide a method for virtual competition, which can display image information of virtual competition even to a third person which is a spectator in addition to a competition person involved and a computer program.

The technical objects of the present invention are not limited to the aforementioned objects, and other objects, which are not mentioned above, will be apparent to a person having ordinary skill in the art from the following description.

### Technical Solution

According to an aspect of the present invention, a method for virtual competition using motion command input includes: analyzing a motion command and matching the analyzed motion command with a particular skill; and transmitting the particular skill to a competing client which is in competition to activate the particular skill, wherein the client displays the particular skill by overlapping the particular skill with the form of a competing user controlling the competing client.

The motion command may be generated by moving, a client which completes with the competing client in a predetermined direction on a 3D virtual axis.

The method may further include collecting result data corresponding to the particular skill in the competing client.

In the displaying, additional information of the competing user may be displayed by using an augmented reality technique.

The additional information of the competing user may include visualized equipment or item information to overlap with the location of the competing user.

The method may further include transmitting to an observation client an observation image including the form of the competing user controlling the competing client and the form of a reference user controlling the client which competes with the competing client.

The observation image may include visualized equipment or item information to overlap with the location of the reference user or the competing user.

The observation image may include a dummy unit disposed outside an area of the reference user or the competing user and the dummy unit may activate the particular skill.

The motion command may be generated by inputting a particular pattern into the client which competes with the competing client.

According to another aspect of the present invention, a computer program is used to implement a function to analyze a motion command and match the analyzed motion command with a particular skill and a function to overlap the particular skill with the form of a competing user and display the form of the competing user overlapped with the particular skill.

It should be understood that different embodiments of the invention, including those described under different aspects of the invention, are meant to be generally applicable to all aspects of the invention. Any embodiment may be combined with any other embodiment unless inappropriate. All examples are illustrative and non-limiting.

### Advantageous Effects

According to the present invention, in performing virtual competition among multiple users facing each other in actual reality, 3-dimensional and live competition can be performed through a motion command input scheme.

Further, virtual reality can be provided, in which figures of opponents themselves can be implanted as game characters by overlapping virtual graphics such as equipment, an item, and an activated skill with an image in which persons in competition project each other.

Moreover, an observation image in which the virtual graphics are overlapped with an actual image of the persons in competition is provided even to a third person who observes the competition in addition to the person in competition, and as a result, multiple users can observe virtual competition and share a competition result.

### BRIEF DESCRIPTION OF THE DRAWINGS

FIG. 1 is a block diagram illustrating a configuration of a method for virtual competition using motion command input according to an exemplary embodiment of the present invention.

FIGS. 2 and 3 are diagrams sequentially describing the method for virtual competition of FIG. 1.

FIG. 4 is a block diagram illustrating a configuration of a method for virtual competition using motion command input according to another exemplary embodiment of the present invention.

FIGS. 5 and 6 are diagrams illustrating one example of an actual implementation screen of a method for virtual competition using motion command input according to yet another exemplary embodiment of the present invention.

FIGS. 7 and 9 are diagrams illustrating examples of an observation image of the method for virtual competition using motion command input according to yet another exemplary embodiment of the present invention.

FIG. 10 is a flowchart illustrating a method for virtual competition using motion command input according to exemplary embodiments of the present invention.

FIG. 11 illustrates one example of a computer in which a computer program is installed according to an exemplary embodiment of the present invention.

### BEST MODE FOR THE INVENTION

Hereinafter, preferred embodiments of the present invention will be described in detail with reference to the accompanying drawings. The advantages and features of the present invention, and methods of accomplishing these will become obvious with reference to examples to be described below in detail along with the accompanying drawings. However, the present invention is not limited to the exemplary embodiments set forth below, and may be embodied in various other forms. The present exemplary embodiments are for rendering the description of the present invention complete and are set forth to provide a complete understanding of the scope of the invention to a person with ordinary skill in the technical field to which the present invention pertains, and the present invention will only be defined by the scope of the claims. Throughout the whole specification, the same reference numerals denote the same elements.

Unless otherwise defined, all terms (including technical and scientific terms) used in the present specification may be used as the same meaning which may be commonly understood by the person with ordinary skill in the art, to which the present invention belongs. It will be further understood that terms defined in commonly used dictionaries should not be interpreted in an idealized or excessive sense unless expressly and specifically defined.

The terms used in the present specification are for explaining the exemplary embodiments rather than limiting the present invention. Unless particularly stated otherwise in the present specification, a singular form also includes a plural form. The meaning of “comprises” and/or “comprising” used in this specification does not exclude the existence or addition of one or more other constituent elements in addition to the mentioned constituent elements.

Hereinafter, a method for virtual competition using motion command input according to an exemplary embodiment of the present invention will be described with reference to drawings.

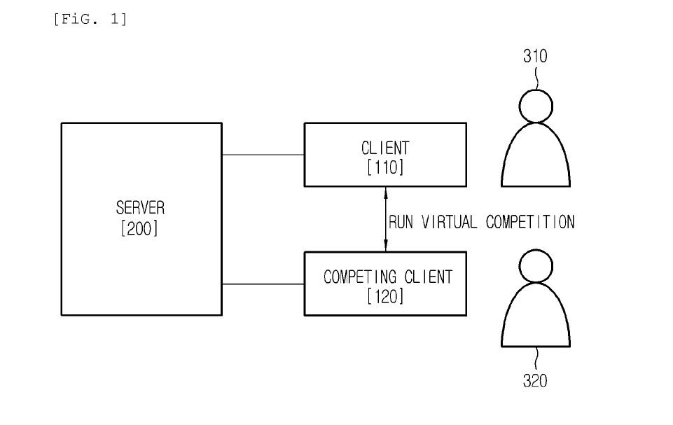

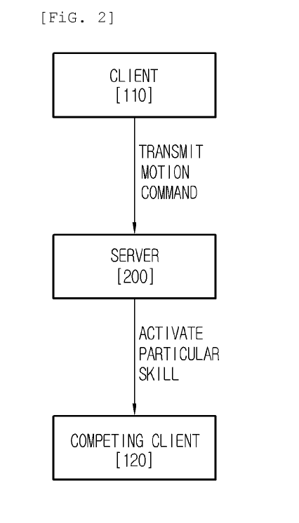

Referring to FIG. 1, a block diagram illustrating a configuration of a method for virtual competition using motion command input according to an exemplary embodiment of the present invention is disclosed. The method for virtual competition according to the exemplary embodiment of the present invention may be constituted by a client 110, a competing client 120, and a server 200, but, the present invention is not limited thereto and as described below, the method for virtual competition may be performed in a P2P scheme without the server 200.

The client 110 and the competing client 120 may have the same configuration, but the present invention is not limited thereto and the client 110 and the competing client 120 may operate in concatenation with each other in heterogeneous platforms.

The client 110 and the competing client 120 may transmit/receive predetermined data to/from each other and as necessary, the client 110 and the competing client 120 may perform data communication with the server 200.

The client 110 or the competing clien 120 may be, for example, a desktop PC, a kiosk, a notebook PC, or a tablet PC, but the present invention is not limited thereto and for example, all types of wireless/wired communication devices which may transmit/receive predetermined data by accessing the server 200 through the Internet.

For example, the client 110 or the competing client 120 may include mobile terminals including a cellular phone, a personal communications services phone (PCS), synchronous/asynchronous International Mobile Telecommunication (IMT-2000), and the like and besides, the client 110 or the competing client 120 may comprehensively mean all wired/wireless home appliance/communication devices having a user interface for accessing the server 200, which include a palm personal computer (PC), a personal digital assistant (PDA), a smart phone, a wireless application Protocol (WAP) phone, a mobile play-station), and the like.

Each of users 310 and 320 who participate in competition may perform a virtual competition game by controlling the client 110 and the competing client 120 and inputs a motion command to transfer the input motion command to an opponent by activating a particular skill.

The motion command may be input in various schemes and for example, a 3D motion using an accelerometer sensor is recognize to recognize the recognized 3D motion by a command operation for revealing the particular skill and besides, when a predetermined pattern is implemented by a touch input scheme and input into an input panel, the predetermined pattern may be recognized by the command operation. Alternatively, the command operation may be performed by using a virtual or physical button or switch.

For example, when the client 110 and the competing client 120 are smart phones, the competing users 310 and 320 input a predetermined motion command while facing each other to give damage to an opponent character through revealing a predetermined skill. An input method of the motion command will be described below in detail.

In some other exemplary embodiments, the client 110 and the competing client 120 may include a wearable computer type client device such as glasses or a hair band. In the case of smart glasses, a virtual image is overlapped with an actual form of an opponent user to implement an effect in which an actual user becomes a game character itself and an effect in which an impact is given to the opponent user may be actually implemented at the time of revealing the skill.

A game in which the client 110 and the competing client 120 compete with each other while facing each other is described as an example, but the present invention is not limited thereto and the game may be implemented even as a game type in which the client 110 and the competing client 120 cooperate with each other to perform a predetermined mission.

The server 200 may include a database for storing and managing the data received from the client 110 and the competing client 120 and store and manage various data including a list of users which are in competition, a competition history, and the like. The database may mean a physical/logical space capable of storing predetermined data and be a component included in the server 200 and the database is provided separately from the server 200 and connected with the server 200 to be communicatable to transmit/receive data.

The first user 310 that controls the client 110 may apply for virtual competition by directly facing the second user 320 offline without passing through the server 200, the client 110 may apply for the virtual competition online by searching a list of users who hope the virtual competition by accessing the server 200, and a particular location and a particular date are designated online and the first user 310 and the second user 320 are gathered at the corresponding location to perform the virtual competition.

It is described that the method for virtual competition according to the exemplary embodiment is performed while the first user 310 and the second user 320 actually face each other offline as an example, but the present invention is not limited thereto and the method may be performed at a remote place.

The method for virtual competition using motion command input according to the exemplary embodiment includes analyzing a motion command and matching the analyzed motion command with a particular skill and transmitting the particular skill to a competing client which is in competition to activate the particular skill and overlapping the particular skill with the form of a competing user controlling the competing client and displaying the overlapped form overlapped with the particular skill.

For example, when it is sensed that the motion command is input in the client 110, this may be analyzed in the client 110 itself or an external component such as the server 200 and when a predetermined motion command is input, the matched particular skill may be activated.

During this process, the client 110 may transmit the particular skill to the competing client 120 and the particular skill is overlapped with a display displaying the form of the second user 320 controlling the competing client 120 to be displayed.

As a result, a person involved, which performs the competition game may feel a 3D effect and reality in which the particular skill is actually transferred to the opponent. To this end, the client 110 and the competing client 120 may include a camera module which may generate an image by photographing an opponent user.

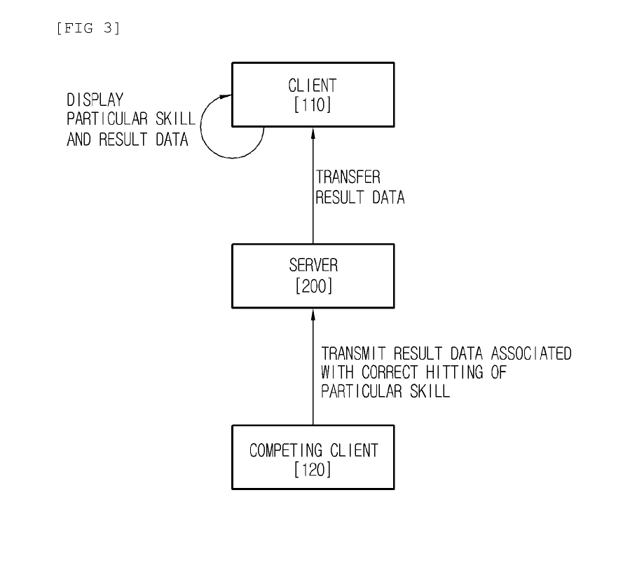

Referring to FIGS. 2 and 3, diagrams sequentially describing the virtual competition method of FIG. 1 are illustrated. When the first user 310 inputs the motion command by controlling the client 110, the motion command is analyzed in the client 110 itself to match the particular skill and as illustrated in FIGS. 2 and 3, the motion command is transmitted to the server 200 and the motion command is analyzed in the server 200 to activate the particular skill. The particular skill revealed as such is transferred to the competing client 120 to cause an effect to the competing client 120.

The competing client 120 to which the particular skill is applied may input a motion command for a defense or avoidance thereto and result data indicating whether the particular skill is correctly hit may be directly transmitted to the client 110 or through the server 200.

During this process, the client 110 and the competing client 120 may visualize and display the particular skill and the result data by using a predetermined synchronization algorithm.

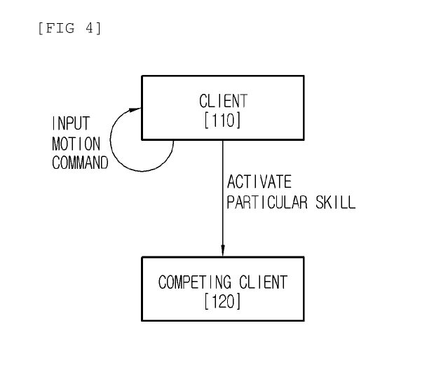

Referring to FIG. 4, a block diagram illustrating a configuration of a method for virtual competition using motion command input according to another exemplary embodiment of the present invention is illustrated. As described above, the method for virtual competition using motion command input according to the exemplary embodiment may be implemented through 1:1 or 1:N communication between the client 110 and the competing client 120 without the configuration of the server 200 and the competition application may be performed between the client 110 and the competing client 120. For example, when the client 110 inputs the motion command, the particular skill matched by searching a match table of the motion command and the particular skill in the client 110 may be transmitted to the competing client 120.

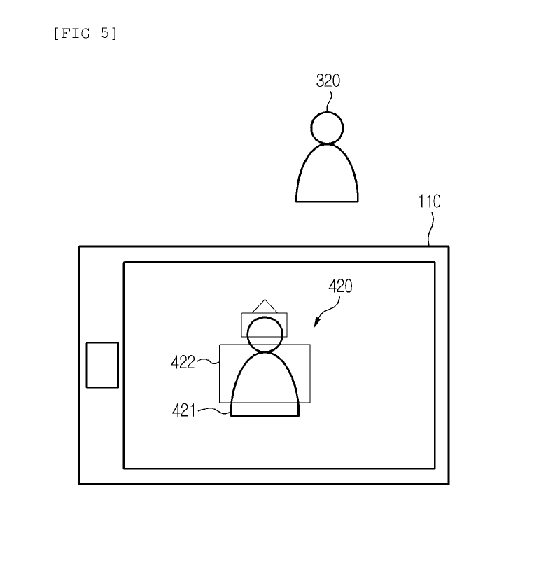

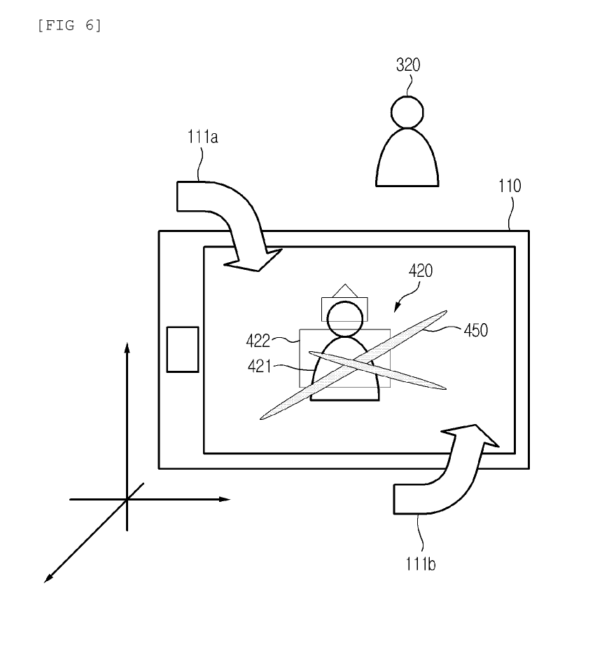

Referring to FIGS. 5 and 6, one example of an actual implementation screen of a method for virtual competition using motion command input according to yet another exemplary embodiment of the present invention is illustrated. As a virtual competition method implemented while the first user 310 and the second user 320 actually face each other, the first and second users 310 and 320 may use the mobile device such as the smart phone as the client 110 and the competing client 120. The illustrated example exemplarily expresses a screen in which the first user 310 projects the second user 320 by using the client 110. In the virtual competition method, when the second user 320 is photographed by using the camera module mounted on the client 110, the form of the second user 320 itself may be substituted with a competition game character 421 and additional information 422 of the competing user 320 may be displayed by using various virtual reality techniques including an augmented reality technique, and the like. The additional information of the competing user 320 may include visualized equipment or item information to overlap with the location of the competing user 320. That is, the second user 320 may be the competition game character 421 in a competition image and various additional information 422 mounted on the character or displayed may be provided. For example, the additional information 422 may be displayed while overlapping with the image of the competing user 320 by visualizing worn equipment, items, and weapons of the competition game character 421.

As described above, motion commands 111a and 111b of FIG. 6 may be generated by moving the client 110 in a predetermined direction on a 3D virtual axis and the motion commands 111a and 111b are sensed to match the particular skill. When the matched particular skill is searched, the particular skill may be activated to the opponent competing client 120. As a result, in a competition image implemented in a display unit of the client 110, an image in which a particular skill 450 is applied to the competition game character 421 of the second user 320 may be overlapped and displayed.

Subsequently, the method may further include collecting result data corresponding to the particular skill 450 in the competing client 120 when the particular skill 450 is implemented. During this process, the competition history may be managed through result data indicating whether the particular skill 450 is accurately applied to the second user 320 or whether the avoidance or defense is performed.

As described above, the motion command may be generated by inputting a particular pattern in the client 110 and such a motion may be a 3D stereoscopic motion and a pattern implemented on a touch panel.

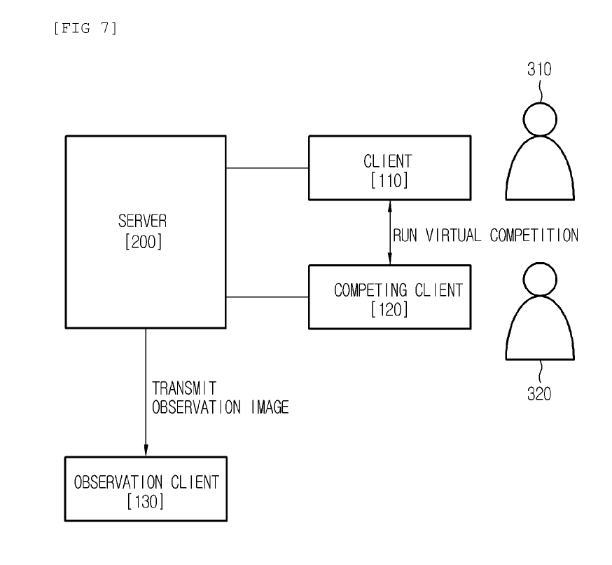

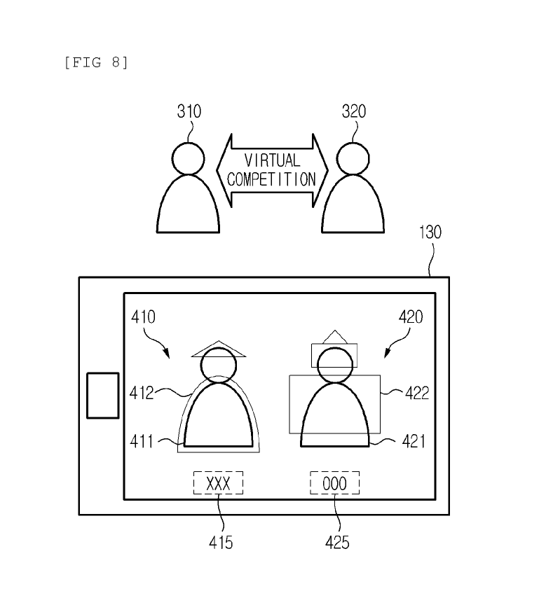

Referring to FIGS. 7 to 9, examples of an observation image of the method for virtual competition using motion command input according to yet another exemplary embodiment of the present invention are illustrated. Offense and defense by the particular skill may be transmitted/received between the client 110 and the competing client controlled by the first user 310 and the second user 320 that perform the virtual competition and the observation user which is the third person receives an observation image for a competition situation through the observation client 130 to observe the competition. Such an observation image may be transferred through the server 200 and the client and competing clients 110 and 120 may directly transmit the observation image.

That is, the observation image including the form of the reference user 310 controlling the client 110 and the form of the competing user 320 controlling the competing client 120 may be transmitted to the observation client 130.

As illustrated in FIG. 8, the observation image may include visualized equipment or item information 412 or 422 to be overlapped with a location of a character 4112 of the reference user 310 and/or a location of a character 421 of the competing user 320.

That is, the first user 310 and the second user 320 which the observation client 130 faces in reality are illuminated with the camera module, and the like, information on the virtual competition may be provided. An activationion situation of the particular skill used by the first user 310 and the second user 320 may be provided together with an equipment or item situation which the first user 310 and the second user 320 mount and a motion command input method for activating the particular skill may also be observed together. Additional information 415 and 425 such as HP or MP information of each user which is in competition may also be provided together.

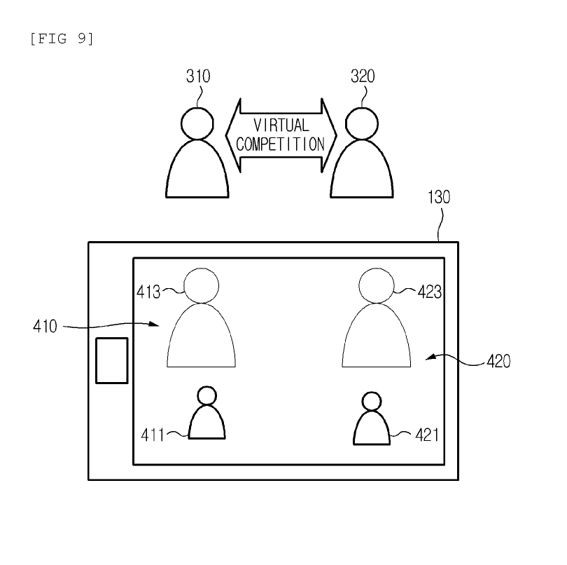

Referring to FIG. 9, the observation image may include dummy units 413 and 423 disposed outside areas of the characters 411 and 421 in the image in which the reference user 310 or the competing user 320 are projected and the image may be implemented in such a manner that the particular skill is activated in the dummy units 413 and 423. Further, the observation image may include visualized equipment or item information to overlap with the locations of the dummy units 413 and 423.

when the particular skill implementation image or the equipment overlapping image gives a sense of difference due to a synchronization problem of the observation image, and the like, the virtual competition game may be performed through the first dummy unit 413 which is an avatar character of the first user 310 and the second dummy unit 423 which is the avatar character of the second user 320 without directly overlapping the equipment, and the like with the first user 310 and the second user 320.

The dummy units 413 and 423 may be disposed in a vertical direction or a horizontal direction of the first and second users 310 and 320 and partially or wholly overlapped with the images of the first and second users 310 and 320.

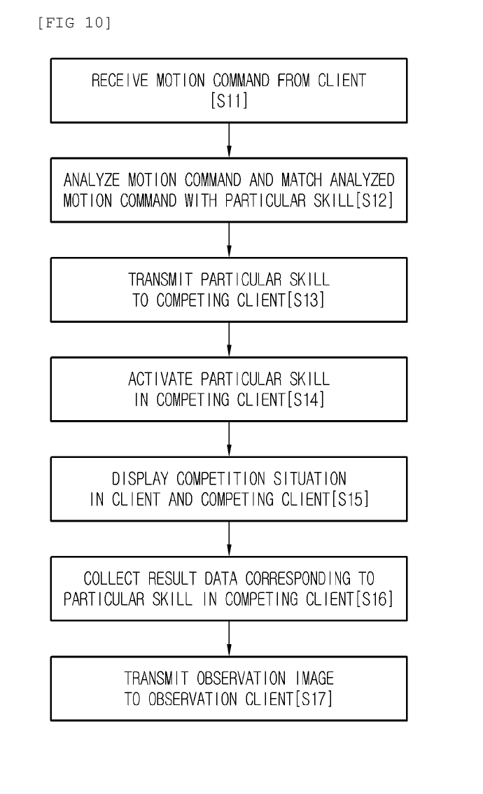

Referring to FIG. 10, an exemplary flowchart illustrating a method for virtual competition using motion command input according to exemplary embodiments of the present invention is illustrated.

First, a motion command is received from a client (S11). The received motion command is analyzed to match a particular skill (S12). Such a process may be performed in a server 200 or clients 110 and 120 as described above.

When the particular skill is decided, the decided particular skill may be transmitted to the competing client 120 which is an opponent (S13). In some other exemplary embodiments, the motion command itself may be directly transmitted to the competing client 120 and the motion command is analyzed in the competing client 120 itself to match the particular skill to perform an operation of activating the particular skill (S14).

During this process, the client and the competing clients 110 and 120 may display a competition situation (S15). The particular skill and the virtual equipment on the game may be implemented while being overlapped with the image of the user.

The competing client 120 may collect result data corresponding to the particular skill (S16) and transmit the result data to the client 110.

Subsequently, the observation image is transmitted to the observation client 130, and as a result, a plurality of observers may observe the virtual competition (S17).

A function of the method for virtual competition using motion command input according to the exemplary embodiment of the present invention may be implemented by a computer program.

The computer program according to the exemplary embodiment of the present invention may be installed in a computer such as the client 110, the competing client 120, and the observation client 130.

The computer program according to the exemplary embodiment of the present invention is used to implement a function to analyze a motion command and match the analyzed motion command with a particular skill and a function to overlap the particular skill with the form of a competing user and display the form of the competing user overlapped with the particular skill.

The motion command may be generated by moving the computer in a predetermined direction on a 3D virtual axis.

The computer program according to the exemplary embodiment of the present invention may be used to implement a function to collect result data corresponding to the particular skill.

The function to display the form of the competing user overlapped with the particular skill may display additional information of the competing user by using an augmented reality technique.

The additional information of the competing user may include visualized equipment or item information to overlap with the location of the competing user.

The computer program according to the exemplary embodiment of the present invention may further implement a function to transmit an observation image including the form of a reference user and the form of a competing user which competes with competition.

The observation image may include visualized equipment or item information to overlap with the location of the reference user or the competing user.

The observation image may include a dummy unit disposed outside an area of the reference user or the competing user and the dummy unit may activate the particular skill.

The observation image may include visualized equipment or item information to overlap with the location of the dummy unit.

The motion command may be generated by inputting a particular pattern.

Since various functions of the computer program described as above have been described in detail with reference to FIGS. 1 to 10, description thereof will be omitted.

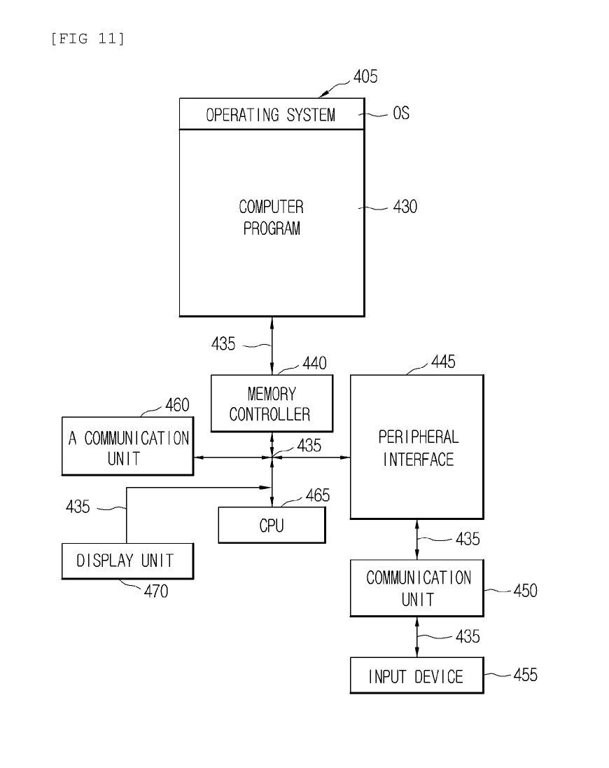

FIG. 11 illustrates one example of a computer in which a computer program is installed according to an exemplary embodiment of the present invention.

The computer program according to the exemplary embodiment of the present invention may be installed on a computer-readable recording medium 705. The computers may be various apparatuses such as a smart phone, a notebook, a PC, a tablet, and a server, but are not limited thereto.

The components of the computer may communicate with each other through one or more communication buses or signal lines 435. The computer may have less or more components than illustrated in FIG. 11. A day computer illustrated in FIG. 11 may be implemented by hardware, software, or a combination thereof.

The recording medium 705 may store software components and the software components may include an operating system (OS) and the computer program according to the exemplary embodiment of the present invention.

The recording medium 705 may be a CD, a DVD, a USB, a hard disk, a RAM, a flash memory or a remote storage unit which is accessible through a network.

The operating system (OS) may include various software components and drivers for controlling a general system task. Further, the operating system (OS) may convert data into a packet type in order to transmit a search result, visualized data for the search result, analysis, and additional analysis.

The operating system (OS) may be Linux, Unix, a Window based server OS, iOS, an Android OS, or a Window based PC OS, but is not limited thereto.

A CPU 465 loads and executes the software components such as the operating system (OS) and the computer program 410.

A memory controller 440 may control other components such as the CPU 465 or a peripheral interface 445 to access the recording medium 405.

A communication unit 460 is used to access the network such as the Internet or a mobile communication network or communicate with another adjacent computing device.

The peripheral interface 445 may connect an input device 455 such as a mouse, a keyboard, or a touch screen to the CPU 465 and a recording medium 705.

An input device controller 450 receives an electric signal input from an input device 455 and converts the electric signal so as to match a standard of the communication bus or signal line 435.

A display unit 470 may display an operating situation of the computer program according to the exemplary embodiment of the present invention.

The computer program according to the exemplary embodiment of the present invention may be transmitted to and installed in the client 110, the competing client 120, and the observation client 130 through App Store of Apple or App Market of Google, but the present invention is not limited thereto.

The exemplary embodiments of the present disclosure have been described above with reference to the accompanying drawings, but those skilled in the art will understand that the present disclosure may be implemented in another particular form without changing the technical spirit or an essential feature thereof. Therefore, the aforementioned exemplary embodiments are all illustrative and are not restricted to a limited form.

1. A method for virtual competition using motion command input, the method comprising:
analyzing a motion command and matching the analyzed motion command with a particular skill; and
transmitting the particular skill to a competing client which is in competition to activate the particular skill, wherein the particular skill is displayed by overlapping the particular skill with the form of a competing user controlling the competing client.

2. The method of claim 1, wherein the motion command is generated by moving a client which completes with the competing client in a predetermined direction on a 3D virtual axis.

3. The method of claim 1, further comprising:
collecting result data corresponding to the particular skill in the competing client.

4. The method of claim 1, wherein in the displaying, additional information of the competing user is displayed by using an augmented reality technique.

5. The method of claim 4, wherein the additional information of the competing user includes visualized equipment or item information to overlap with a location of the competing user.

6. The method of claim 1, further comprising:
transmitting to an observation client an observation image including the form of the competing user controlling the competing client and the form of a reference user controlling the client which competes with the competing client.

7. The method of claim 6, wherein the observation image includes visualized equipment or item information to overlap with the location of the reference user or the competing user.

8. The method of claim 6, wherein the observation image includes a dummy unit disposed outside an area of the reference user or the competing user and the dummy unit activates the particular skill.

9. The method of claim 8, wherein the observation image includes visualized equipment or item information to overlap with a location of the dummy unit.

10. The method of claim 1, wherein the motion command is generated by inputting a particular pattern into the client which competes with the competing client.

11. A computer program installable in computer, comprising:
a function to analyze a motion command and matching the analyzed motion command with a particular skill; and a
function to transmit the particular skill and overlapping the particular skill with the form of a competing user and display the overlapped form overlapped with the particular skill.

12. The computer program of claim 11, wherein the motion command is generated by moving the computer in a predetermined direction on a 3D virtual axis.

13. The computer program of claim 11, wherein the compute program is used to implement a function to collect result data corresponding to the particular skill.

14. The computer program of claim 11, wherein the displaying function displays additional information of the competing user by using an augmented reality technique.

15. The computer program of claim 14, wherein the additional information of the competing user includes visualized equipment or item information to overlap with a location of the competing user.

16. The computer program claim 11, further comprising:
a function to transmit an observation image including the form of a reference user and the form of the competing user which competes with the reference user.

17. The computer program of claim 16, wherein the observation image includes visualized equipment or item information to overlap with the location of the reference user or the competing user.

18. The computer program of claim 16, wherein the observation image includes a dummy unit disposed outside an area of the reference user or the competing user and the dummy unit activates the particular skill.

19. The computer program of claim 18, wherein the observation image includes visualized equipment or item information to overlap with a location of the dummy unit.

20. The computer program of claim 11, wherein the motion command is generated by inputting a particular pattern.
